(19) United States
(12) Patent Application Publication
(10) Pub. No.: US 2026/0067721 A1
(43) Pub. Date: Mar. 5, 2026

(54) COMMUNICATION METHOD IN AN AUTOMATED SMART-METER MANAGEMENT SYSTEM

(71) Applicant: SAGEMCOM ENERGY & TELECOM SAS, Bois-Colombes (FR)

(72) Inventors: Henri TEBOULLE, Bois-Colombes (FR); Christophe GRINCOURT, Bois-Colombes (FR)

(73) Assignee: SAGEMCOM ENERGY & TELECOM SAS, Bois-Colombes (FR)

(21) Appl. No.: 19/311,748

(22) Filed: Aug. 27, 2025

(30) Foreign Application Priority Data
Aug. 29, 2024 (FR) 2409208

(51) Int. Cl. H04W 24/04; H04W 88/06

(52) U.S. Cl. CPC H04W 24/04; H04W 88/06

(57) ABSTRACT

A smart meter that includes a first communication interface providing a first communication channel with an information system using the internet, by means of a residential gateway, and a second communication interface providing a second communication channel using a cellular network. The smart meter implements a first communication mode in which a main communication channel is used to communicate data relating to metering operations, and functioning-verification messages are transmitted on the other communication channel. In a second communication mode, the reverse is implemented. The smart meter switches onto the second communication mode when the main communication channel becomes inoperative, and switches onto the first communication mode again when at least one functioning-verification message receives an acknowledgement on the main communication channel.

### TECHNICAL FIELD

At least one embodiment relates to a communication method in an automated smart meter management system, such as electricity consumption meters, water consumption meters, gas consumption meters, etc.

### PRIOR ART

Smart meters are known, of the energy meter type (electricity meters, heat meters, etc) or fluid meters (fluid-consumption meters: water, gas, etc), which comprise communication interfaces enabling an automated management system to implement a remote collection of consumption data. Consumption data can thus be transmitted, at regular intervals or on demand, to an information system IS processing them in a centralised manner.

For example, smart meters communicate with the information system IIS using a cellular communication infrastructure of the 5G (5th Generation) type, or of the GPRS type (“General Packet Radio Service”), or of the UMTS type (“Universal Mobile Telecommunication System”), or of the LTE-MTC type (“Long-Term Evolution Machine Type Communication”), also known by the diminutive LTE-M, or of the NB-IoT type (“NarrowBand Internet of Things”).

A problem is posed when the cellular communication infrastructure is unavailable. Operations of reading metering data, or of reconfiguring smart meters, are then delayed until the cellular communication infrastructure is once again available.

It is desirable to provide a solution that makes it possible to overcome at least this drawback of the prior art.

### DISCLOSURE OF THE INVENTION

For this purpose, a method is proposed for the communication of a smart meter with an information system remotely managing the smart meter in an automated management system, the smart meter comprising: a first communication interface providing a first communication channel with the information system using the internet by means of a residential gateway; and a second communication interface providing a second communication channel using a cellular network. The method is such that the smart meter implements a first communication mode comprising:
using a communication channel, referred to as the main communication channel, from the first and second communication channels, to communicate data relating to metering operations;
transmitting, to the information system, messages verifying functioning on the other communication channel, referred to as the secondary communication channel.

In addition, the method is such that the smart meter implements a second communication mode comprising:
using the secondary communication channel for communicating the data relating to the metering operations;
transmitting, to the information system, the messages verifying functioning on the main communication channel.

And the method is such that the smart meter furthermore implements:
switching to the second communication mode when the main communication channel becomes inoperative; and
switching again to the first communication mode when at least one said functioning-verifying message receives an acknowledgement from the information system on the main communication channel.

Thus two communication channels are made available to the smart meter. A communication channel passing through a cellular network, and a communication channel passing through the internet by means of a residential gateway, typically that of the subscriber to which the smart meter is allocated. A main communication channel is defined from the two communication channels available (for example, the communication channel via the internet) and, when the main channel is unavailable, the other communication channel is used. Functioning-verifying messages are used for verifying that the communication channel that is not being used at that moment for communicating the data relating to the metering operations is still functional.

According to a particular embodiment, the second communication channel passes by means of a media converter comprising a cellular communication interface for communicating with the information system and a short-range communication interface for communicating with the smart meter, the media converter serving as an intermediary between the smart meter and the information system on the second communication channel.

According to a particular embodiment, before enabling the communication of the data relating to metering operations on either one of the communication channels from the first and second communication channels, pairing is implemented between the smart meter and the information system by means of the media converter on the second communication channel.

According to a particular embodiment, the smart meter switches from the first communication mode to the second communication mode when the smart meter receives a request from the information system via the second communication channel whilst, for the smart meter, the first communication mode was active.

According to a particular embodiment, when neither of the first and second communication channels is functional, the smart meter transmits the functioning-verifying messages on each of the first and second communication channels.

A computer program product is also proposed here, comprising instructions for implementing the method disclosed above in any one of the embodiments thereof, when the instructions are executed by a processor. An information storage medium is also proposed here, storing instructions for implementing the method disclosed above in any one of the embodiments thereof, when the instructions are read from the information storage medium and executed by a processor.

A smart meter is also proposed here intended to be used in an automated management system comprising an information system remotely managing smart meters of the automated management system, wherein the smart meter in question comprises: a first communication interface providing a first communication channel with the information system using the internet by means of a residential gateway; and a second communication interface providing a second communication channel using a cellular network.

In addition, the smart meter furthermore comprises electronic circuitry configured to implement a first communication mode comprising:
using, principally, a communication channel, referred to as the main communication channel, from the first and second communication channels, to communicate data relating to metering operations;
transmitting, to the information system, messages verifying functioning on the other communication channel, referred to as the secondary communication channel.

The electronic circuitry of the smart meter is furthermore configured to implement a second communication mode comprising:
using the secondary communication channel for communicating the data relating to the metering operations;
transmitting, to the information system, the messages verifying functioning on the main communication channel.

And the electronic circuitry of the smart meter is furthermore configured to:
switch to the second communication mode when the main communication channel becomes inoperative; and
switch again to the first communication mode when at least one said functioning-verifying message receives an acknowledgement from the information system on the main communication channel.

An automated management system is also proposed here, comprising an information system and a plurality of smart meters as disclosed above, each smart meter being associated with a residential gateway by means of which to communicate via the first communication channel.

In a particular embodiment, the automated management system comprises at least one media converter serving as an intermediary between a group of said smart meters and the information system on the second communication channel, the media converter comprising a cellular communication interface for communicating with the information system and a short-range communication interface for communicating with the smart meters in the group.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an automated smart-meter management system in which the present invention can be implemented;

FIG. 2 illustrates schematically an example of hardware architecture of a device of the automated management system;

FIG. 3 illustrates schematically exchanges occurring in the automated management system for implementing pairing between a smart meter and an information system;

FIG. 4 illustrates schematically exchanges occurring in the automated management according to a first communication mode;

FIG. 5 illustrates schematically exchanges occurring in the automated management according to a second communication mode; and

FIG. 6 illustrates schematically a state machine switching between in particular the first communication mode and the second communication mode.

### DETAILED DISCLOSURE OF EMBODIMENTS

FIG. 1 illustrates schematically an automated management system 100 in which the present invention can be implemented. The automated management system 100 is configured to make a collection of consumption data resulting from measurements made by smart meters.

The consumption data collected are processed by an information system IS 110 that remotely manages the smart meters.

The information system IS 110 is centralised management equipment and the smart meters are registered with the information system IS 110, in accordance with subscriptions taken out by respective users (called “subscribers”) with a distributor for which said information system IS 110 operates.

For example, the smart meters are water meters, gas meters, electricity meters, etc.

For example, the information system IS 110 comprises various components including a head-end system HES, a meter data management system MDMS, and a key management system KMS. The head-end system HES is configured to implement the management of transmissions in the context of consumption data collection. The meter data management system MDMS is configured to process the consumption data collected. The key management system KMS is configured to store encryption keys necessary for the meter data management system MDMS and for the smart meters, as well as any intermediate equipment between the information system IS 110 and the smart meters in question. The components of the information system IS 110 communicate for example using the internet, or more generally a network of the IP (“Internet Protocol”) type, or potentially using a Virtual Private Network VPN.

The information system INS 110 comprises a first communication interface 220 for communicating via the internet 101 (marked INT on FIG. 1) and a second communication interface 240, long-range, for communicating via a cellular network CEL 102. Such an arrangement thus provides two communication channels with the information system IS 110 to allow the remote management of the smart meters.

For example, the cellular network CEL 102 is a wireless communication network of the 5G (5th Generation) type. According to other examples, the cellular network CEL 102 is a wireless communication network of the following types: GPRS (“General Packet Radio Service”), UMTS (“Universal Mobile Telecommunication System”), LTE-MTC (“Long-Term Evolution Machine Type Communication”), also known by the diminutive LTE-M, or NB-IOT (“NarrowBand Internet of Things”).

Two smart meters SM_1 211, SM_2 212 are shown illustratively on FIG. 1. The automated management system typically comprises a much greater number of smart meters.

The smart meters SM_1 211, SM_2 212 each comprise a first communication interface for using the first communication channel with the information system IS 110 using the internet 101, by means of a residential gateway. Each of the smart meters SM_1 211, SM_2 212 is thus respectively associated with a residential gateway RGW_1 201, RGW_2 202. These residential gateways RGW_1 201, RGW_2 202 are installed at respective subscribers that hold the smart meters SM_1 211, SM_2 212. In other words, the smart meter SM_1 211 and the residential gateway RGW_1 201 are installed to offer respective services (consumption metering in one case, access to the internet 101 in the other) at premises 261 of a first subscriber, and the smart meter SM_2 212 and the residential gateway RGW_2 202 are installed to offer said respective services at premises 262 of a second subscriber.

Each residential gateway RGW_1 201, RGW_2 202 then comprises an interface 220 for communication with the INTERNET 101, thus making it possible to communicate by this means with the information system IS 110. In a particular embodiment, a virtual private network VPN can be established between each residential gateway RGW_1 201, RGW_2 202 and the information system IS 110 to protect the exchanges.

By means of this first communication interface, the smart meters SM_1 211, SM_2 212 communicate with the residential gateway RGW_1 201, RGW_2 202, typically in Wi-Fi. Other short-range communication technologies can be used in a variant, for example Ethernet, Bluetooth, Zigbee, KNX, KNX-RF, etc. The residential gateway RGW_1 201, RGW_2 202 can then be caused to implement a media-converter function and thus make message-format conversions.

The smart meters SM_1 211, SM_2 212 thus each comprise a second communication interface providing a second communication channel using the cellular network CEL 102.

In a first implementation, this second communication interface is a long-range communication interface, of the cellular type, making it possible to communicate with the information system IS 110 directly via the cellular network CEL 102.

In a second implementation, this second communication interface is a short-range communication interface making it possible to communicate with a device that serves as an intermediary with the cellular network CEL 102 and therefore with the information system IS 110.

Thus, in a particular embodiment related to this second implementation, the automated management system 100 makes it possible to manage installations 260 equipping blocks of flats or residential units where a group of smart meters of various subscribers is located. To do this, as illustrated in FIG. 1, a media converter MC 200 is used. The media converter MC 200 makes it possible to manage this group of smart meters and therefore to serve as an intermediary between the information system IS 110 on the one hand and the smart meters in the group on the other hand.

The presence of the media converter MC 200 makes it possible to equip the smart meters in the group with short-range communication means rather than having to equip them with long-range communication means, of the cellular type, for communicating with the information systems IS 110 via the cellular network CEL 102. The media converter MC 200 thus makes it possible to reduce the complexity and the manufacturing cost of smart meters, since short-range communication technologies are typically less complex and expensive than long-range ones of the cellular type.

Thus, as illustrated schematically in FIG. 1, the smart meters SM_1 211, SM_2 212 are the smart meters in a group. The smart meters SM_1 211, SM_2 212 and the media converter MC 200 are provided with a short-range communication interface 250. For example, the short-range communication interface 250 is adapted to establish a communication link in accordance with the M-Bus (“Meter Bus”) remote-reading specifications as defined in EN 13757-2 or in accordance with the wM-Bus (“Wireless M-Bus”) specifications as defined in EN 13757-4. Other short-range communication technologies can be used, such as Bluetooth, Zigbee, KNX, KNX-RF, etc. Then the smart meters SM_1 211, SM_2 212 in the group comprise a first short-range communication interface 230 for communicating with the residential gateways RGW_1 201, RGW_2 202 that are respectively associated therewith and a second short-range communication interface 250 for communicating with the media converter MC 200. For its part, the media converter MC 200 comprises a first long-range communication interface, of the cellular type, 240 for communicating with the information system IS 110 and a second short-range communication interface 250 for communicating with the smart meters SM_1 211, SM_2 212 in the group.

As detailed below, the smart meters SM_1 211, SM_2 212 comprise electronic circuitry adapted and configured to selectively use the first communication channel or the second communication channel for communicating data relating to metering operations. The data relating to metering operations are for example metering readings transmitted by the smart meter in question to the information system IS 110, register-reading results transmitted by the smart meter in question to the information system IS 110, action orders transmitted by the information system IS 110 to the smart meter in question, configuration (or reconfiguration) data transmitted by the information system IS 110 to the smart meter in question, etc.

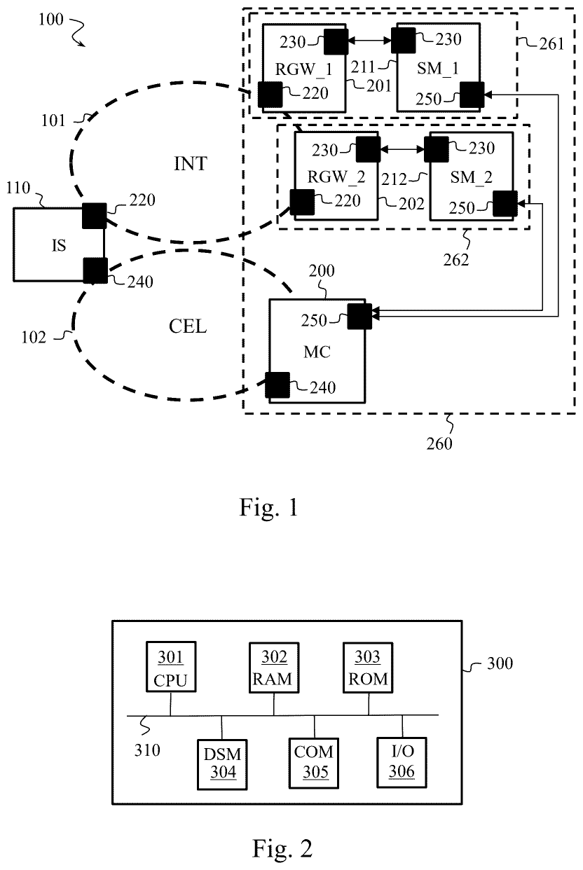

FIG. 2 illustrates schematically an example of hardware architecture 300, which is adapted to implement any device controller of the automated management system 100. The example of hardware architecture is thus adapted to implement a controller of an information system IS, or of any component of the information system IS. The example of hardware architecture is also adapted to implement a smart-meter controller. The example of hardware architecture is also adapted to implement a controller of a media converter MC 200.

The hardware architecture 300 then comprises, connected by a communication bus 310: a processor or CPU (“Central Processing Unit”) 301; a random access memory RAM 302; a read-only memory ROM 303, or EEPROM (“Electrically Erasable Programmable ROM”), or a flash memory; a data storage medium DSM 304, such as a hard disk drive HDD, or a storage medium reader, such as an SD (“Secure Digital”) card reader; and at least one communication interface COM 305. According to the device in question, the hardware architecture 300 may further comprise inputs/outputs I/O 306, for example to make consumption measurements.

The processor 301 is capable of executing instructions loaded in the RAM 302 from the ROM 303, from an external memory (not shown), from a storage medium such as an SD card, or from a communication network. When the hardware architecture 300 is powered up, the processor 301 is capable of reading instructions from the RAM 302 and executing them. These instructions form a computer program causing the implementation, by the processor 301, of the steps and algorithms described here in relation to the device or equipment concerned.

All or some of the steps and algorithms described here can thus be implemented in software form by executing a set of instructions by a programmable machine, such as a DSP (“digital signal processor”) or a microcontroller, or be implemented in hardware form by a machine or a component (“chip”) or a set of components (“chipset”), such as an FPGA (“field-programmable gate array”) or an ASIC (“application-specific integrated circuit”). In general terms, each device or item of equipment of the automated management system 100 comprises electronic circuitry arranged and configured to implement the steps and algorithms described here in relation to the device or equipment in question.

To enable a said smart meter to communicate data relating to metering operations with the information system IS 110, a pairing is implemented. This pairing can be implemented by manual configuration, or be implemented automatically. A particular pairing mode is described below.

In a particular embodiment, before enabling the communication of data relating to metering operations on either one of the communication channels among the first and second communication channels, a pairing is implemented between the smart meter in question and the information system IS 110 by means of the media converter MC 200 on the second communication channel.

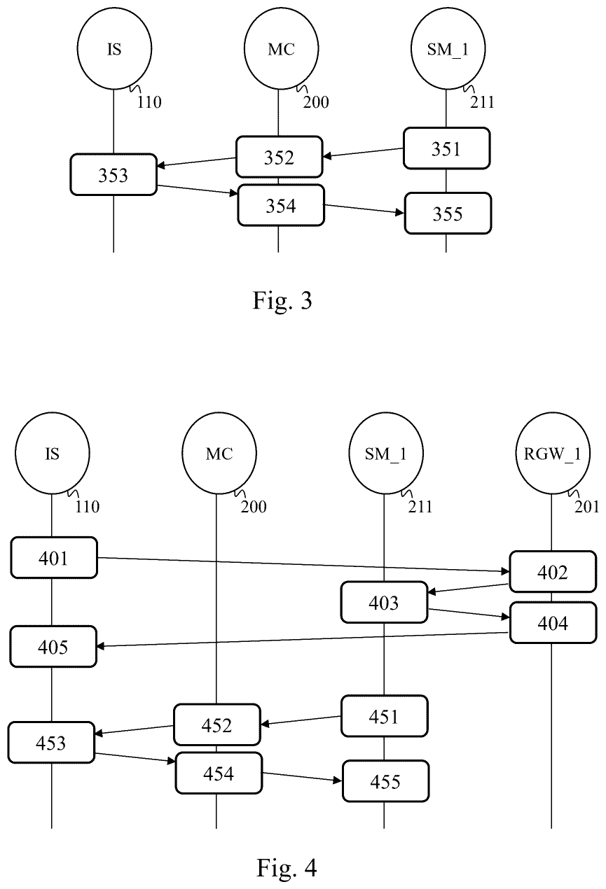

FIG. 3 illustrates schematically exchanges occurring in the automated management system 100 for implementing this pairing.

We consider hereinafter, for example, that the pairing relates to the smart water meter SM_1 211.

In a step 351, the smart meter SM_1 211 triggers a pairing request, which causes the sending, by the smart meter SM_1 211, to the media converter MC 200 of a pairing request.

In a particular embodiment, the smart meter SM_1 211 has a button, for example on the front face, on which to press (e.g. long pressing with a duration greater than 2 seconds) to trigger a pairing request. The pairing request can in a variant be triggered by selecting an element in a scroll-down menu of a man-machine interface of the smart meter SM_1 211. The pairing request can again in a variant be triggered by receiving an external message or instruction, for example coming from the media converter MC 200.

The pairing request is a message that includes:
information on type of message (in clear), which identifies that the message is a pairing request;
information on the smart-meter identifier, in encrypted form, which identifies the smart meter in question, this identifier being known to the information system IS 110.

The smart-meter identifier information is for example a serial number of the smart meter in question or information derived from said serial number.

The smart-meter identifier information is preferentially encrypted by means of an asymmetric key K_DSO, which is specific to the information system IS 110 and is known to the smart meter in question.

The symmetric key K_DSO is for example configured, in the memory of the smart meter in question (here the smart meter SM_1 211), in the factory or when the smart meter in question is installed and the subscription is taken out with the distributor concerned.

In a particular embodiment, the smart meter in question has another symmetric key MK_DSO, specific to the information system IS 110. This symmetric key MK_DSO is called the master key and is used for encrypting other keys.

In a step 352, the media converter MC 200 receives the pairing request sent by the smart meter SM_1 211 at the step 351. The media converter MC 200 implements a format conversion so as to relay the pairing request to the information system IS 110 via the cellular network CEL 102.

Prior to the on-site installation of the media converter MC 200, the information relating to the information system IS 110 with which the smart meters at the subscribers behind the media converter MC 200 (i.e. the smart meters in the group) are liable to be paired are programmed in the media converter MC 200 (in the factory, at the installer or on site, typically).

The media converter MC 200 then transmits to the information system IS 110 a relayed pairing request. Said relayed pairing request contains at a minimum the smart-meter identifier information as presented in the pairing request sent by the smart meter SM_1 211 (i.e. in encrypted form).

It should be noted that, at this stage, the exchanges between the smart meter SM_1 211 and the media converter MC 200 are not encrypted. As explained below, the exchanges between each smart meter in the group and the media converter MC 200 can subsequently, in a particular embodiment, be encrypted by means of a symmetric key K_WM specific to the smart meter in question.

The exchanges between the media converter MC 200 and the information system IS 110 via the cellular network CEL 102 are implemented by means of a secure protocol, so as to ensure at least the confidentiality of the data exchanged, for example by means of the TLS (“Transport Layer Security”) protocol.

In a step 353, the information system IS 110 receives the relayed pairing request and decrypts the smart-meter identifier information. And after decryption by means of the symmetric key K_DSO, the information system IS 110 recognises the smart-meter identifier information as corresponding to a smart-meter identifier that must be attached to it (i.e. subscription taken out with the distributor concerned). Then the information system IS 110 responds to the media converter MC 200 by a positive acknowledgement to the relayed pairing request.

The positive acknowledgement is a message that includes:
information on type of message (in clear), which identifies that the message is a positive acknowledgement to a pairing request;
the symmetric key K_WM specific to the smart meter SM_1 211, in clear; and
the same symmetric key K_WM, encrypted by means of the master key MK_DSO.

Other information, intended for the smart meter SM_1 211, can be included in a form encrypted by means of the symmetric key K_DSO in the positive acknowledgement, such as for example configuration information to be applied by the smart meter SM_1 211.

Like the rest of the exchanges between the media converter MC 200 and the information system IS 110, the positive acknowledgement is transmitted by means of a secure protocol, for example by means of the TLS protocol.

In a step 354, the media converter MC 200 receives the positive acknowledgement. The media converter MC 200 reads and stores the symmetric key K_WM supplied in clear (beyond the encryption, for example by means of the TLS protocol, applied in the exchanges between the media converter MC 200 and the information system IS 110) in the positive acknowledgement transmitted by the information system IS 110.

Next the media converter MC 200 generates a pairing-acceptance message intended for the smart meter SM_1 211 including the symmetric key K_WM, encrypted by means of the master key MK_DSO (i.e. as presented in the positive acknowledgement transmitted by the information system IS 110).

Once the pairing-acceptance message has been received, in a step 355, the smart meter SM_1 211 can decrypt the symmetric key K_WM by means of the master key MK_DSO, which makes it possible to subsequently encrypt the exchanges between the smart meter SM_1 211 and the media converter MC 200.

The smart meter SM_1 211 is then paired with the information system IS 110 and data relating to metering operations can then be exchanged between the smart meter SM_1 211 and the information system IS 110. These data can be encrypted end to end with the key K_DSO. The exchanges between the smart meter SM_1 211 and the information system IS 110 can for example rely on the DLMS/COSEM (“Device Language Message Specification/Companion Specification for Energy Metering”) or LwM2M (“Lightweight Machine to Machine”) protocol. Thus, when the second communication channel (via the cellular network CEL 102) by means of the media converter MC 200 is used, the media converter MC 200 does not have access to these data exchanged between the smart meter SM_1 211 and the information system IS 110. Likewise, when the first communication channel (via the internet 101) by means of the residential gateway RGW_1 201 is used, the residential gateway RGW_1 201 does not have access to these data exchanged between the smart meter SM_1 211 and the information system IS 110.

To communicate data relating to metering operations, the smart meter SM_1 211 and information system IS 110 implement a first communication mode in which a communication channel, referred to as the main communication channel, from the first and second communication channels is used. In addition, the smart meter SM_1 211 transmits, to the information system IS 110, messages verifying functioning on the other communication channel, referred to as the secondary communication channel. These functioning-verification messages are sometimes called messages of the “Keep-Alive” type.

When the information system IS 110 receives these functioning-verification messages, the information system IS 110 responds thereto by acknowledgements also via the secondary communication channel. This enables the smart meter SM_1 211 and the information system IS 110 to know whether the secondary communication channel is operational or not, and whether the secondary communication channel can serve or not as a backup communication channel in the event of failure of the main communication channel.

The smart meter SM_1 211 and the information system IS 110 also implement a second communication mode that uses the secondary communication channel for communicating the data relating to the metering operations; In this second communication mode, the smart meter SM_1 211 transmits, to the information system IS 110, messages verifying functioning on the main communication channel. When the information system IS 110 receives these functioning-verification messages, the information system IS 110 responds thereto by acknowledgements also via the main communication channel. This enables the smart meter SM_1 211 and the information system IS 110 to know whether the main communication channel is operational or not, and whether a return of communications via the main communication channel can or cannot be implemented.

The functioning-verification messages are regularly sent, on one or other communication channel, according to the communication mode that is active among the first and second communication modes. For example, the functioning-verification messages are sent at regular time intervals.

Preferentially, the main communication channel is the first communication channel (via the internet 101) and the secondary communication channel is the second communication channel (via the cellular network CEL 102).

FIG. 4 illustrates schematically exchanges occurring in the automated management system 100 according to the first communication mode, considering here that the main communication channel is the first communication channel (via the internet 101) and the secondary communication channel is the second communication channel (via the cellular network CEL 102).

In a step 401, the information system IS 110 transmits a request to the smart meter SM_1 211 via the first communication channel. The request is received by the residential gateway RGW_1 201 in a step 402, and the residential gateway RGW_1 201 relays the request to the smart meter SM_1 211.

In a step 403, the smart meter SM_1 211 receives the request, processes the request and transmits a response to the information system IS 110 via the first communication channel. The response is received by the residential gateway RGW_1 201 in a step 404, and the residential gateway RGW_1 201 relays the response to the information system IS 110.

In a step 405, the information system IS 110 receives the response and processes it.

It should be noted that the exchanges on the first communication for communicating the data relating to the metering operations can take place in the other direction, i.e. at the initiative of the smart meter SM_1 211.

In a step 451, the smart meter SM_1 211 transmits, to the information system IS 110, a message verifying functioning on the second communication channel. They functioning-verification message is received by the media converter MC 200 in a step 452, and the media converter MC 200 relays the functioning-verification message to the information system IS 110.

In a step 453, the information system IS 110 receives the functioning-verification message via the second communication channel. The information system IS 110 then knows that the second communication channel is operational and generates an acknowledgement that the information system IS 110 transmits to the smart meter SM_1 211 also via the second communication channel. The acknowledgement is received by the media converter MC 200 in a step 454, and the media converter MC 200 relays the acknowledgement to the smart meter SM_1 211.

In a step 455, the smart meter SM_1 211 receives the acknowledgement and processes it. The smart meter SM_1 211 then knows that the second communication channel is operational.

When the smart meter SM_1 211 does not receive an acknowledgement for a predetermined number N (N≥1) of successive functioning-verification messages, this means that the secondary communication channel (here the second communication channel) is inoperative and that it is not desirable to implement switching onto the second communication channel. The smart meter SM_1 211 continues however to send functioning-verification messages on the secondary channel in the hope that the latter is re-established and that acknowledgements are then once again received.

When the smart meter SM_1 211 does not receive a new request from the information system IS 110 via the main communication channel for a preprogrammed period (for example for 3 hours), the main communication channel is considered to have become inoperative and switching onto the second communication mode is implemented. The smart meter SM_1 211 can also detect that the main communication channel has become inoperative when the smart meter SM_1 211 receives a request from the information system IS 110 via the secondary communication channel whereas, from the point of view of the smart meter SM_1 211, the first communication mode was active. This means that the information system IS 110 has detected for its part that the main communication channel had become inoperative and has switched onto the secondary communication channel. The smart meter SM_1 211 then also switches onto the secondary communication channel and activates the second communication mode. This situation occurs when the information system IS 110 has not received a response from the smart meter SM_1 211 via the main communication channel for a predetermined number M (M>1, for example M=3) of successive requests.

Likewise, when the exchange is at the initiative of the smart meter SM_1 211 and the smart meter SM_1 211 does not receive a response from the information system IS 110 via the main communication channel for the predetermined number M (M>1, for example M=3) of successive requests, the smart meter SM_1 211 detects that the main communication channel has become inoperative and switches onto the secondary communication channel while activating the second communication mode. The information system IS 110 then receives a request from the smart meter SM_1 211 via the secondary communication channel whereas, from the point of view of the information system IS 110, the first communication mode was active. The information system IS 110 then also switches onto the secondary communication channel and activates the second communication mode.

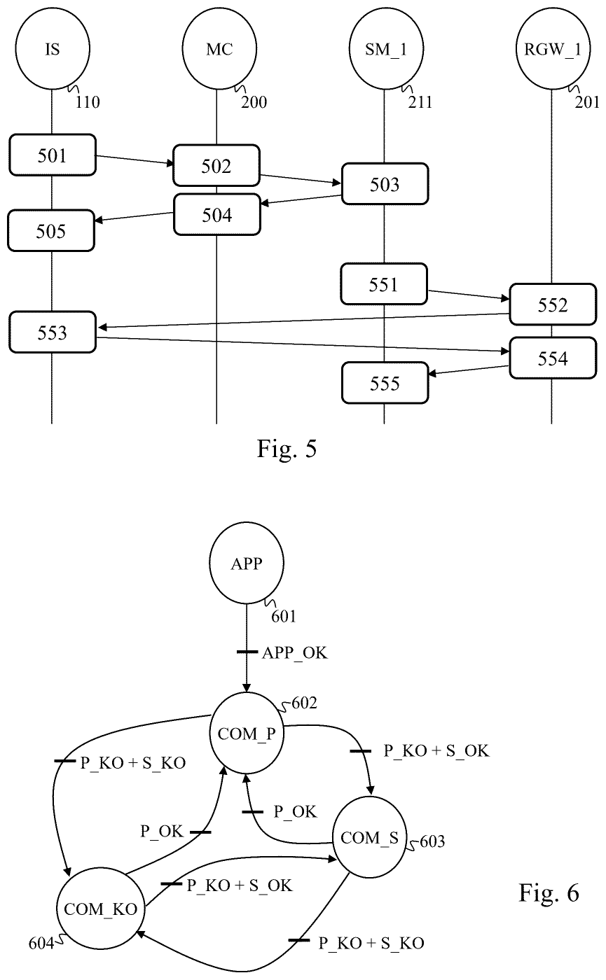

FIG. 5 illustrates schematically exchanges occurring in the automated management system 100 according to the second communication mode, considering here again that the main communication channel is the first communication channel (via the internet 101) and the secondary communication channel is the second communication channel (via the cellular network CEL 102).

In a step 501, the information system IS 110 transmits a request to the smart meter SM_1 211 via the second communication channel. The request is received by the media converter MC 200 in a step 502, and the media converter MC 200 relays the request to the smart meter SM_1 211.

In a step 503, the smart meter SM_1 211 receives the request, processes the request and transmits a response to the information system IS 110 also via the second communication channel. The response is received by the media converter MC 200 in a step 504, and the media converter MC 200 relays the response to the information system IS 110.

In a step 505, the information system IS 110 receives the response and processes it.

It should be noted that the exchanges on the second communication for communicating the data relating to the metering operations can take place in the other direction, i.e. at the initiative of the smart meter SM_1 211.

In a step 551, the smart meter SM_1 211 transmits, to the information system IS 110, a message verifying functioning on the first communication channel. The functioning-verification message is received by the residential gateway RGW_1 201 in a step 552, and the residential gateway RGW_1 201 relays the functioning-verification message to the information system IS 110.

When the main communication channel is still not operative, the functioning-verification message does not reach the information system IS 110, and consequently the smart meter SM_1 211 will not receive a response to its functioning-verification message. The second communication mode will then have to be maintained.

We consider hereinafter that the main communication channel (here the first communication channel) has become operative again.

Then, in a step 553, the information system IS 110 receives the functioning-verification message via the first communication channel. The information system IS 110 then knows that the first communication channel is operational and generates an acknowledgement that the information system IS 110 transmits to the smart meter SM_1 211 also via the first communication channel. The acknowledgement is received by the residential gateway RGW_1 201 in a step 554, and the residential gateway RGW_1 201 relays the acknowledgement to the smart meter SM_1 211.

In a step 555, the smart meter SM_1 211 receives the acknowledgement and processes it. The smart meter SM_1 211 then knows that the first communication channel is once again operational.

In this situation, the smart meter SM_1 211 and the information system IS 110 switch again onto the first communication mode for the remainder of the exchanges.

In to a particular embodiment, when neither of the communication channels among the first and second communication channels is functional, the smart meter SM_1 211 transmits functioning-verifying messages to the information system IS 110 on each of the first and second communication channels. When, after a certain amount of time, the smart meter SM_1 211 receives an acknowledgement over at least one of the first and second communication channels, the smart meter SM_1 211 and the information system IS 110 activate the appropriate communication mode from the first and second communication modes: the first communication mode is activated if an acknowledgement is received over the main communication channel, and the second communication mode is activated if an acknowledgement is received over the secondary communication channel.

FIG. 6 illustrates schematically a state machine for switching between in particular the first communication mode and the second communication mode. The state machine can be applied by the information system IS 110 and by each smart meter in the automated management system 100.

The state machine begins in an initialisation state 601. As illustrated in FIG. 6, this initialisation state is a pairing state APP 601 in which pairing operations are performed to attach the smart meter in question (for example the smart meter SM_1 211) to the information system IS 110.

When the pairing has ended successfully, a transition APP_OK switches the state machine into a state COM_P 602 in which the first communication mode is active and the main communication channel is used for communicating data relating to the metering operations. In addition, functioning-verification messages are transmitted by the smart meter in question over the secondary communication channel.

In the state COM_P 602, when the main communication channel becomes inoperative and the secondary communication channel is operational, a transition P_KO+S_OK switches the state machine into a state COM_S 603 in which the second communication mode is active and the secondary communication channel is used for communicating the data relating to the metering operations. In addition, functioning-verification messages are transmitted by the smart meter in question over the main communication channel.

In the state COM_P 602, when the main communication channel becomes inoperative and the secondary communication channel also inoperative, a transition P_KO+S_OK switches the state machine into a state COM_KO 604 in which functioning-verification messages are transmitted by the smart meter in question over the main communication channel and over the secondary communication channel. No data relating to the metering operations can then be transmitted.

In the state COM_S 603, when the secondary communication channel becomes inoperative and the main communication channel is still inoperative, a transition P_KO+S_OK switches the state machine into the state COM_KO 604.

In the state COM_S 603, when the main communication channel becomes operational again, a transition P_OK switches the state machine into the state COM_P 602.

In the state COM_S 604, when the main communication channel becomes operational again, a transition P_OK switches the state machine into the state COM_P 602.

In the state COM_S 604, when the secondary communication channel becomes operational again and the main communication channel is still inoperative, a transition P_KO+S_OK switches the state machine into the state COM_S 603.

1. A method for a smart meter to communicate with an information system remotely managing the smart meter in an automated management system, the smart meter comprising:
a first communication interface providing a first communication channel with the information system using the internet, by means of a residential gateway;
a second communication interface providing a second communication channel using a cellular network;
wherein the smart meter implements a first communication mode comprising:
using a communication channel, referred to as the main communication channel, from the first and second communication channels, to communicate data relating to metering operations;
transmitting, to the information system, messages verifying functioning on the other communication channel, referred to as the secondary communication channel;
and the smart meter implements a second communication mode comprising:
using the secondary communication channel for communicating the data relating to the metering operations;
transmitting, to the information system, the messages verifying functioning on the main communication channel;
and the smart meter furthermore implements:
switching to the second communication mode when the main communication channel becomes inoperative; and
switching again to the first communication mode when at least one said functioning-verifying message receives an acknowledgement from the information system on the main communication channel.

2. The method according to claim 1, wherein the second communication channel passes by means of a media converter comprising a cellular communication interface for communicating with the information system and a short-range communication interface for communicating with the smart meter, the media converter serving as an intermediary between the smart meter and the information system on the second communication channel.

3. The method according to claim 1, wherein, before enabling the communication of data relating to metering operations on either one of the communication channels among the first and second communication channels, a pairing is implemented between the smart meter and the information system by means of the media converter on the second communication channel.

4. The method according to claim 1, wherein the smart meter switches from the first communication mode to the second communication mode when the smart meter receives a request from the information system via the second communication channel whilst, for the smart meter, the first communication mode was active.

5. The method according to claim 1, wherein, when neither of the first and second communication channels is functional, the smart meter transmits the functioning-verifying messages on each of the first and second communication channels.

6. (canceled)

7. A non-transitory information storage medium comprising instructions for implementing the method according to claim 1, when the instructions are read from the information storage medium and implemented by a processor.

8. A smart meter intended to be used in an automated management system comprising an information system remotely managing smart meters of the automated management system, wherein the smart meter in question comprises:
a first communication interface providing a first communication channel with the information system using the internet, by means of a residential gateway;
a second communication interface providing a second communication channel using a cellular network;
and wherein the smart meter furthermore comprises electronic circuitry configured to implement a first communication mode comprising:
using, principally, a communication channel, referred to as the main communication channel, from the first and second communication channels, to communicate data relating to metering operations;
transmitting, to the information system, messages verifying functioning on the other communication channel, referred to as the secondary communication channel;
and the electronic circuitry of the smart meter is furthermore configured to implement a second communication mode comprising:
using the secondary communication channel for communicating the data relating to the metering operations;
transmitting, to the information system, the messages verifying functioning on the main communication channel;
and the electronic circuitry of the smart meter is furthermore configured to:
switch to the second communication mode when the main communication channel becomes inoperative; and
switch again to the first communication mode when at least one said functioning-verifying message receives an acknowledgement from the information system on the main communication channel.

9. An automated management system comprising an information system and a plurality of smart meters, where each smart meter is according to the smart meter of claim 8, each smart meter being associated with a residential gateway by means of which to communicate via the first communication channel.

10. The automated management system according to claim 9, comprising at least one media converter serving as an intermediary between a group of said smart meters and the information system on the second communication channel, the media converter comprising a cellular communication interface for communicating with the information system and a short-range communication interface for communicating with the smart meters in the group.
